(19) United States
(12) Patent Application Publication
(10) Pub. No.: US 2002/0038194 A1
(43) Pub. Date: Mar. 28, 2002

(54) Method and system for ensuring approved weighing

(76) Inventors: Giora Klimberg, Ra'anana (IL); Benjamin Shaya, Kfar Saba (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/920,405

(22) Filed: Aug. 2, 2001

Related U.S. Application Data
(60) Provisional application No. 60/222,668, filed on Aug. 3, 2000.

(51) Int. Cl. G01G 7/00; G01G 9/00; G01G 11/00; G06F 15/00; G06F 15/02; G01G 17/00; G01G 19/00

(52) U.S. Cl. 702/173

(57) ABSTRACT

A method and apparatus for approved calibrated weighing is provided. The method comprising comparing an identification code provided by a load cell with a predefined identification code stored in an electronic weighing unit coupled to the load cell and accepting a weight signal provided by the load cell only if the identification code provided by the load cell matches the predefined identification code.

### CROSS-REFERENCE TO RELATED APPLICATIONS

The present application claims priority from U.S. provisional application serial No. 60/222,668, filed Aug. 3, 2000.

### BACKGROUND OF THE INVENTION

Most manufacturers of weighing systems refer to the International Recommendations of the International Organization of Legal Metrology (OIML) to ensure that their products meet international specifications. According to the OIML regulations, weighing systems are equipped with one or more physical security seals that must be broken before performing any change that may affect the calibration of the system.

For example, in order to replace a load cell, a security seal protecting the load cell is irreversibly broken. In such a way, any attempt to reach the load cell can be detected. It would be advantageous to provide a method to secure weighing devices that may eliminate the need for physical security seals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a weighing system according to some embodiments of the present invention; and

FIG. 2 shows a flowchart diagram of the operation of the system of FIG. 1 according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

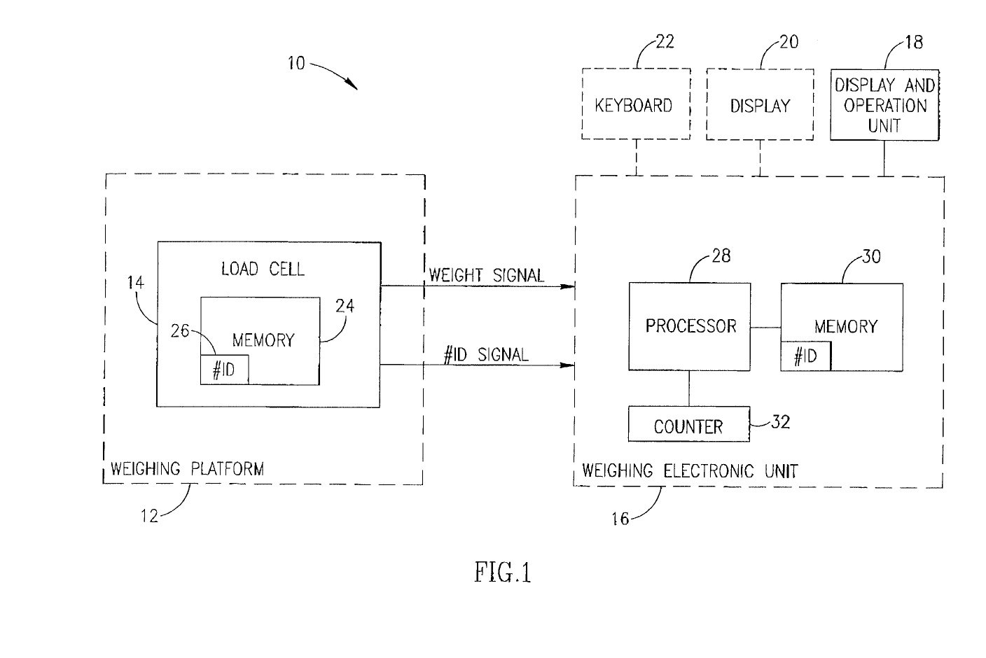

Reference is now made to FIG. 1, which illustrates a weighing system according to some embodiments of the present invention. A weighing system 10 may comprise a weighing platform 12, at least one load cell 14 coupled to weighing platform 12 and a weighing electronic unit 16 coupled to load cell 14. Load cell 14 may be coupled to electronic unit 16 via an electrical connection such as, for example, excitation voltage and signal voltages, excitation voltage and current signals, a serial bit stream and a parallel bit stream. Load cell 14 may be remotely coupled to electronic unit 16. Load cell 14 and electronic unit 16 may be configured according to the OIML-R60 and the OIML-R76 recommendations, respectively.

Weighing system 10 may further comprise a display and operation unit 18 and additionally or alternatively a display 20 and a keyboard 22, all coupled to weighing electronic unit 16.

Non-limiting examples of display and operation unit 18 include a personal computer, a point of sale, a programmable logic controller (PLC) and a cash register (CR). Non-limiting examples of display 20 include a light-emitting diode (LED) display, a liquid crystal display (LCD), a vacuum fluorescent display (VFD), an alphanumeric display, a 7-segment display, a graphic display and a dot matrix display.

Load cell 14 may comprise a memory 24 having an unchangeable load cell identification (ID) code 26. Non-limiting examples of memory 24 may include read only memory (ROM), electrically erasable programmable read only memory (EEPROM), electrically programmable read only memory (EPROM), flash memory and other non-volatile memories. ID code 26 may be, for example, a serial number, a cryptological code or any other identification data, which is uniquely correlated to the load cell.

It should be understood to a person skilled in the art that the identification code is not limited to a specific length. The code may be encrypted using known cryptological means such as, for example, public key encryption, DES keys and any linear transformation of an identification code. Alteratively, the ID code may be transmitted over the interface lines as clear data.

Weighing electronic unit 16 may be realized as a chipset or as an application-specific integrated circuit (ASIC) independent of the load cell. Weighing electronic unit 16 may comprise a processor 28 and a memory 30 coupled to processor 28. Non-limiting examples of memory 30 may include ROM, EEPROM, EPROM, Flash memory and other non-volatile memories.

Electronic unit 16 may further comprise a calibration counter 32 in order to prevent fraud in accordance with the OIML-R76 recommendations, National Institute of Standards and Technology (NIST) handbook 44, chapter 1.10 section G-S.8 and as advised by the European Cooperation in Legal Metrolooy (WELMEC) Guide for examination of software, chapter 2.3.

Memory 30 may be able to store at least the ID code 26. Weighing electronic unit 16 may also store a maintenance code. The maintenance code may be used by authorized personnel for maintenance purposes.

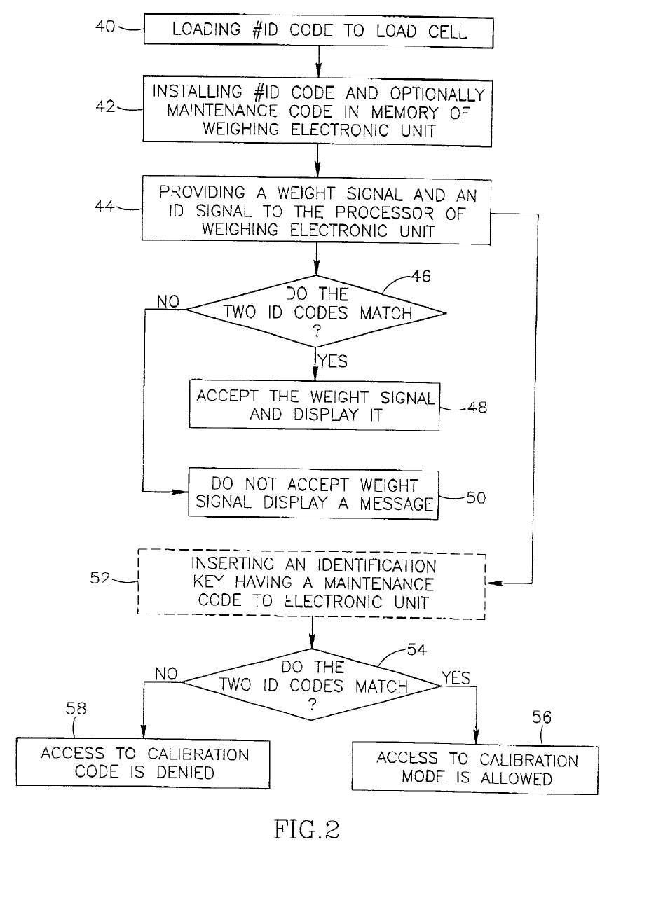

Reference is now made to FIG. 2, which is a flow chart representing the operation of weighing system 10 of FIG. 1, according to some embodiments of the present invention. The components of the system such as, for example, the load cell, the electronic circuit and the display module may be separately installed. Load cell ID code 26 may be loaded to load cell 14 during the production of the load cell. Alternatively, the ID code may be loaded to load cell 14 during calibration of weighing system 10 (step 40).

During calibration, the calibration counter (not shown) of weighing electronic unit 16 may be set and the value of the counter is registered. Additionally, according to some embodiments of the present invention, load cell ID code 26 associated with load cell 14, which is coupled to electronic unit 16, may be recorded in memory 30 of weighing electronic unit 16 (step 42).

During operation, electronic unit 16 may receive a weight signal from load cell 14. The weight signal received from load cell 14 may be an analog signal or a digital signal. Additionally, weighing electronic unit 16 may receive a load cell ID signal from load cell 14 (step 44). The signals may be provided to electronic unit 16 via a communication interface using a wired or wireless communication network. Non-limiting examples of communication interface include a serial protocol interface (SPI), RS-232 interface, I²C interface, infrared transmitters, radio frequency (RF) transmitters, and an electro-magnetic interface. The communication interface may be a serial interface, a parallel interface, a synchronous interface and an asynchronous interface.

Processor 28 may compare the load cell ID code in the ID signal to a predefined ID stored in memory 30 (step 46). If the load cell ID codes match, processor 28 may accept the weight signal and the weight may be displayed on display 20 and/or display and operating unit 18 and/or may be sent to other peripheral devices (step 48). If the ID codes do not match, weighing electronic unit 16 may not accept the weight signal and may not perform the weighing operation (step 50). Additionally, weighing electronic unit 16 may send a notification to display 20 about a possible fraud event and/or loss of calibration of the system.

If load cell 14 has to be replaced, an authorized person may insert an identification key comprising a maintenance code to electronic unit 16 (step 52). The identification key may be a physical key, a code and any combination thereof. The maintenance code in the identification key may be compared to a predefined maintenance code stored in memory 30 (step 54). If the maintenance codes match, weighing electronic unit 16 may enable the user to enter a calibration mode and to replace the load cell ID element with a new load cell ID associated with a new load cell (step 56). If the maintenance codes do not match, entrance to the calibration mode may be denied (step 58).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A load cell able to provide an identification code stored therein to an independent unit.

2. A load cell comprising:
a memory storing an identification code associated with said load cell.

3. An system comprising:
a load cell having a load cell identification code associated with said load cell stored therein; and
a memory having a predefined identification code associated with said load cell stored therein.

4. The system of claim 3 further comprising:
a processor able to compare said load cell identification code with said predefined identification code and to accept weight signal from said load cell if said load cell identification code matches said predefined identification code.

5. The system of claim 4, wherein said memory has a predefined maintenance code stored therein.

6. The system of claim 5, wherein said processor is able to compare a system maintenance code provided by a user with said predefined maintenance code and to allow said user to perform maintenance operations if said system maintenance code matches said predefined maintenance code.

7. An electronic weighing unit comprising:
a memory able to store an identification code associated with a load cell coupled to said electronic weighing unit; and
a processor able to compare said identification code with another identification code provided by said load cell.

8. A method comprising:
comparing an identification code provided by a load cell with a predefined identification code stored in an electronic weighing unit coupled to said load cell; and
accepting a weight signal provided by said load cell only if said identification code provided by said load cell matches said predefined identification code.

9. The method of claim 8 further comprising:
comparing a system maintenance code provided by a user with a predefined maintenance code and to allow said user to perform maintenance operations if said system maintenance code matches said predefined maintenance code.
